(19) United States
(12) Patent Application Publication
(10) Pub. No.: US 2026/0212273 A1
(43) Pub. Date: Jul. 23, 2026

(54) Automated Data Transmission Filtering and Classification Using Context Recognition

(71) Applicant: Bonfy.AI, Inc., Mountain View, CA (US)

(72) Inventors: Neta Gur-Ari Krakover, Palo Alto, CA (US); Danny Kibel, Campbell, CA (US); Gideon Cohen, Palo Alto, CA (US)

(21) Appl. No.: 19/451,684

(22) Filed: Jan. 16, 2026

Related U.S. Application Data
(60) Provisional application No. 63/747,870, filed on Jan. 21, 2025.

(51) Int. Cl. G06N 20/00

(52) U.S. Cl. CPC G06N 20/00

(57) ABSTRACT

A system includes memory hardware configured to store instructions and processing hardware configured to execute the instructions. The instructions include receiving an analysis data set, generating elements, and determining whether a first subset of elements is similar to an entry of a knowledge graph. The instructions include, in response to a determination that the first subset is similar to the entry, traversing the graph to determine a set of related entries and determining whether a second subset of elements is similar to a related entry. The instructions include, in response to a determination that the second subset is similar to a related entry, determining whether the entry or the related entry is associated with rules. The instructions include, in response to a determination that the entry or the related entry is associated with the rules, determining whether to perform actions.

### CROSS-REFERENCE TO RELATED APPLICATIONS

This application claims the benefit of U.S. Provisional Application No. 63/747,870 filed Jan. 21, 2025 (Attorney Docket No. 59318-2). The entire disclosure of the above application is incorporated by reference.

### FIELD

The present disclosure relates to automated data processing, and more particularly to using machine learning models to perform automated actions based on context recognition and entity linking.

### BACKGROUND

Widescale data monitoring and filtering is a complex task that requires insight and knowledge of data policies as well as the context and meaning of the monitored data. A solution is required for the automated execution of data policy rules based on the data context.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes memory hardware configured to store instructions and processing hardware configured to execute the instructions stored by the memory hardware. The instructions include receiving an analysis data set. The instructions include generating a set of elements associated with the analysis data set. The instructions include determining whether a first subset of elements of the set of elements is similar to an entry of a knowledge graph. The instructions include, in response to a determination that the first subset of elements is similar to the entry of the knowledge graph, traversing the knowledge graph to determine a set of related entries based on the entry. The instructions include, in response to a determination that the first subset of elements is similar to the entry of the knowledge graph, determining whether a second subset of elements of the set of elements is similar to at least one related entry of the set of related entries. The instructions include, in response to a determination that the second subset of elements is similar to the at least one related entry, determining whether the entry or the at least one related entry is associated with a set of rules. The instructions include, in response to a determination that the entry or the at least one related entry is associated with the set of rules, determining whether to perform a set of actions.

In other features, the set of elements includes at least one of a first set of terms, a first set of entities, a first set of embeddings, or a first set of unique identifiers. In other features, generating the set of elements includes at least one of using regular expressions to determine at least one data type associated with the analysis data set; identifying, using natural language processing (NLP), a first entity of the first set of entities; identifying, using NLP, the first set of unique identifiers based on the analysis data set; determining the first set of embeddings; identifying, using a large language model (LLM), a second entity of the first set of entities; or identifying, using the LLM, a second unique identifier of the first set of unique identifiers.

In other features, the instructions include updating the knowledge graph by receiving a learning data set, determining a set of schemas based on the learning data set, determining, via embedding calculations, a second set of embeddings, determining a set of terms, and adding the set of schemas, the second set of embeddings, and the set of terms to the knowledge graph. In other features, the set of terms is determined by determining, via natural language processing (NLP), a second set of named entities, determining, via NLP, a second set of unique identifiers, determining, using regular expressions, a set of data types associated with a portion of the learning data set, and determining, via an LLM, a third set of unique identifiers and a third set of named entities.

In other features, determining whether the first subset of elements is similar to the entry includes determining a confidence level that the first subset of elements is similar to the entry, determining whether the confidence level meets a confidence threshold, and in response to a determination that the confidence level meets the confidence threshold, determining that the first subset of elements is at least a partial match of the entry.

In other features, determining the confidence level is based on at least one of whether the first subset of elements and the entry include a data pattern, or whether a substring of the first subset of elements matches a substring of the entry. In other features, the data pattern is defined by one or more predefined regular expressions.

In other features, determining the confidence level is based on whether the substring of the first subset of elements matches the substring of the entry. In other features, one or more matching substrings include at least one of: one or more same characters in the same order or one or more same characters within a proximity threshold.

In other features, determining whether the first subset of elements is similar to the entry is performed by a first machine learning model. The confidence level is determined by the first machine learning model. In other features, the instructions include receiving user input related to the determination that the first subset of elements is similar to the entry. In other features, the instructions include training the first machine learning model with the user input.

In other features, the instructions include receiving an additional set of data and merging, via a second machine learning model, the knowledge graph with the additional set of data. In other features, the instructions include receiving the set of rules. In other features, the instructions include receiving a set of data management restrictions and generating, via a machine learning model, a second set of rules based on the set of data management restrictions.

In other features, the instructions include receiving a set of user input related to a respective rule of the set of rules. In other features, the instructions include, in response to receiving the set of user input, updating the respective rule, including at least one of modifying a set of application criteria of the respective rule or modifying a set of actions associated with the respective rule.

In other features, determining whether to perform the set of actions includes, in response to a determination that the confidence level meets the confidence threshold, determining, based on the first subset of elements and the second subset of elements, whether a set of rules criteria associated with the set of rules has been met. In other features, determining whether to perform the set of actions includes, in response to a determination that the set of rules criteria has been met, determining the set of actions. The set of actions is based on the set of rules and includes performing the set of actions.

In other features, the set of actions includes at least one of masking a first portion of the analysis data set, modifying a second portion of the analysis data set, tagging a third portion of the analysis data set, determining a recipient of the analysis data set, or requesting secondary authorization to transmit, access, and/or upload the analysis data set. In other features, the analysis data set does not include a name of the recipient.

In other features, the set of rules includes at least one of determining a quantity associated with the entry in the analysis data set, determining a recipient of the analysis data set, or determining a security level requirement with the analysis data set.

In other features, the learning data set and the analysis data set include at least one of text data, image data, audio data, metadata, video data, machine-readable data, or executable program data. In other features, the instructions include preprocessing the analysis data set and the learning data set. Preprocessing the analysis data set and the learning data set includes at least one of performing hypertext markup language (HTML) extraction, performing optical character recognition, transcribing, translating, performing machine vision analysis, data extraction, chunking, or performing data escaping.

In other features, the instructions include, in response to the determination that the second subset of elements is similar to the at least one related entry, submitting the first subset of elements, the second subset of elements, and the analysis data set to a machine learning model. In other features, the instructions include verifying, via the machine learning model, whether the first subset of elements corresponds to the entry.

In other features, the instructions include determining a first score based on a frequency of the entry in the analysis data set. In other features, the instructions include determining a second score based on a frequency of the entry in a second set of data. In other features, the instructions include determining, based on the first score and the second score, a likelihood that the first subset of elements matches the entry. In other features, the instructions include determining whether the likelihood meets a threshold likelihood level and in response to determining that the likelihood does not meet the threshold likelihood level, determining that the first subset of elements do not correspond to the entry.

A non-transitory computer-readable medium includes processor-executable instructions. The instructions include receiving an analysis data set. The instructions include generating a set of elements associated with the analysis data set. The instructions include determining whether a first subset of elements of the set of elements is similar to an entry of a knowledge graph. The instructions include, in response to a determination that the first subset of elements is similar to the entry of the knowledge graph, traversing the knowledge graph to determine a set of related entries based on the entry. The instructions include, in response to a determination that the first subset of elements is similar to the entry of the knowledge graph, determining whether a second subset of elements of the set of elements is similar to at least one related entry of the set of related entries. The instructions include, in response to a determination that the second subset of elements is similar to the at least one related entry, determining whether the entry or the at least one related entry is associated with a set of rules. The instructions include, in response to a determination that the entry or the at least one related entry is associated with the set of rules, determining whether to perform a set of actions.

In other features, the set of elements includes at least one of a first set of terms, a first set of entities, a first set of embeddings, or a first set of unique identifiers. In other features, generating the set of elements includes at least one of using regular expressions to determine at least one data type associated with the analysis data set; identifying, using natural language processing (NLP), a first entity of the first set of entities, identifying; using NLP, the first set of unique identifiers based on the analysis data set; determining the first set of embeddings; identifying, using a large language model (LLM), a second entity of the first set of entities; or identifying, using the LLM, a second unique identifier of the first set of unique identifiers.

In other features, the instructions include updating the knowledge graph by receiving a learning data set, determining a set of schemas based on the learning data set, determining, via embedding calculations, a second set of embeddings, determining a set of terms, and adding the set of schemas, the second set of embeddings, and the set of terms to the knowledge graph. In other features, the set of terms is determined by determining, via natural language processing (NLP), a second set of named entities, determining, via NLP, a second set of unique identifiers, determining, using regular expressions, a set of data types associated with a portion of the learning data set, and determining, via an LLM, a third set of unique identifiers and a third set of named entities.

In other features, determining whether the first subset of elements is similar to the entry includes determining a confidence level that the first subset of elements is similar to the entry, determining whether the confidence level meets a confidence threshold, and in response to a determination that the confidence level meets the confidence threshold, determining that the first subset of elements is at least a partial match of the entry.

In other features, determining the confidence level is based on at least one of whether the first subset of elements and the entry include a data pattern, or whether a substring of the first subset of elements matches a substring of the entry. In other features, the data pattern is defined by one or more predefined regular expressions.

In other features, determining the confidence level is based on whether the substring of the first subset of elements matches the substring of the entry. In other features, one or more matching substrings include at least one of one or more same characters in a same order, or one or more same characters within a proximity threshold.

In other features, determining whether the first subset of elements is similar to the entry is performed by a first machine learning model. The confidence level is determined by the first machine learning model. In other features, the instructions include receiving user input related to the determination that the first subset of elements is similar to the entry. In other features, the instructions include training the first machine learning model with the user input.

In other features, the instructions include receiving an additional set of data and merging, via a second machine learning model, the knowledge graph with the additional set of data. In other features, the instructions include receiving the set of rules. In other features, the instructions include receiving a set of data management restrictions and generating, via a machine learning model, a second set of rules based on the set of data management restrictions.

In other features, the instructions include receiving a set of user input related to a respective rule of the set of rules. In other features, the instructions include, in response to receiving the set of user input, updating the respective rule, including at least one of modifying a set of application criteria of the respective rule or modifying a set of actions associated with the respective rule.

In other features, determining whether to perform the set of actions includes, in response to a determination that the confidence level meets the confidence threshold, determining, based on the first subset of elements and the second subset of elements, whether a set of rules criteria associated with the set of rules has been met. In other features, determining whether to perform the set of actions includes, in response to a determination that the set of rules criteria has been met, determining the set of actions. The set of actions is based on the set of rules and performing the set of actions.

In other features, the set of actions includes at least one of masking a first portion of the analysis data set, modifying a second portion of the analysis data set, tagging a third portion of the analysis data set, determining a recipient of the analysis data set, or requesting secondary authorization to transmit, access, and/or upload the analysis data set. In other features, the analysis data set does not include a name of the recipient.

In other features, the set of rules includes at least one of determining a quantity associated with the entry in the analysis data set, determining a recipient of the analysis data set, or determining a security level requirement with the analysis data set.

In other features, the learning data set and the analysis data set include at least one of text data, image data, audio data, metadata, video data, machine-readable data, or executable program data. In other features, the instructions include preprocessing the analysis data set and the learning data set. Preprocessing the analysis data set and the learning data set includes at least one of performing hypertext markup language (HTML) extraction, performing optical character recognition, transcribing, translating, performing machine vision analysis, data extraction, chunking, or performing data escaping.

In other features, the instructions include, in response to the determination that the second subset of elements is similar to the at least one related entry, submitting the first subset of elements, the second subset of elements, and the analysis data set to a machine learning model. In other features, the instructions include, verifying, via the machine learning model, whether the first subset of elements corresponds to the entry.

In other features, the instructions include determining a first score based on a frequency of the entry in the analysis data set. In other features, the instructions include determining a second score based on a frequency of the entry in a second set of data. In other features, the instructions include determining, based on the first score and the second score, a likelihood that the first subset of elements match the entry. In other features, the instructions include determining whether the likelihood meets a threshold likelihood level and in response to determining that the likelihood does not meet the threshold likelihood level, determining that the first subset of elements do not correspond to the entry.

A method includes generating a set of elements associated with the analysis data set. The method includes determining whether a first subset of elements of the set of elements is similar to an entry of a knowledge graph. The method includes, in response to a determination that the first subset of elements is similar to the entry of the knowledge graph, traversing the knowledge graph to determine a set of related entries based on the entry. The method includes, in response to a determination that the first subset of elements is similar to the entry of the knowledge graph, determining whether a second subset of elements of the set of elements is similar to at least one related entry of the set of related entries. The method includes, in response to a determination that the second subset of elements is similar to the at least one related entry, determining whether the entry or the at least one related entry is associated with a set of rules. The method includes, in response to a determination that the entry or the at least one related entry is associated with the set of rules, determining whether to perform a set of actions.

In other features, the set of elements includes at least one of a first set of terms, a first set of entities, a first set of embeddings, or a first set of unique identifiers. In other features, generating the set of elements includes at least one of using regular expressions to determine at least one data type associated with the analysis data set; identifying, using natural language processing (NLP), a first entity of the first set of entities, identifying; using NLP, the first set of unique identifiers based on the analysis data set; determining the first set of embeddings; identifying, using a large language model (LLM), a second entity of the first set of entities; or identifying, using the LLM, a second unique identifier of the first set of unique identifiers.

In other features, the method includes updating the knowledge graph by receiving a learning data set, determining a set of schemas based on the learning data set, determining, via embedding calculations, a second set of embeddings, determining a set of terms, and adding the set of schemas, the second set of embeddings, and the set of terms to the knowledge graph. In other features, the set of terms is determined by determining, via natural language processing (NLP), a second set of named entities, determining, via NLP, a second set of unique identifiers, determining, using regular expressions, a set of data types associated with a portion of the learning data set, and determining, via an LLM, a third set of unique identifiers and a third set of named entities.

In other features, determining whether the first subset of elements is similar to the entry includes determining a confidence level that the first subset of elements is similar to the entry, determining whether the confidence level meets a confidence threshold, and in response to a determination that the confidence level meets the confidence threshold, determining that the first subset of elements is at least a partial match of the entry.

In other features, determining the confidence level is based on at least one of whether the first subset of elements and the entry include a data pattern, or whether a substring of the first subset of elements matches a substring of the entry. In other features, the data pattern is defined by one or more predefined regular expressions.

In other features, determining the confidence level is based on whether the substring of the first subset of elements matches the substring of the entry. In other features, one or more matching substrings include at least one of one or more same characters in a same order, or one or more same characters within a proximity threshold.

In other features, determining whether the first subset of elements is similar to the entry is performed by a first machine learning model. The confidence level is determined by the first machine learning model. In other features, the method includes receiving user input related to the determination that the first subset of elements is similar to the entry. In other features, the method includes training the first machine learning model with the user input.

In other features, the method includes receiving an additional set of data and merging, via a second machine learning model, the knowledge graph with the additional set of data. In other features, the method includes receiving the set of rules. In other features, the method includes receiving a set of data management restrictions and generating, via a machine learning model, a second set of rules based on the set of data management restrictions.

In other features, the method includes receiving a set of user input related to a respective rule of the set of rules. In other features, the method includes, in response to receiving the set of user input, updating the respective rule, including at least one of modifying a set of application criteria of the respective rule or modifying a set of actions associated with the respective rule.

In other features, determining whether to perform the set of actions includes, in response to a determination that the confidence level meets the confidence threshold, determining, based on the first subset of elements and the second subset of elements, whether a set of rules criteria associated with the set of rules has been met. In other features, determining whether to perform the set of actions includes, in response to a determination that the set of rules criteria has been met, determining the set of actions. The set of actions is based on the set of rules and performing the set of actions.

In other features, the set of actions includes at least one of masking a first portion of the analysis data set, modifying a second portion of the analysis data set, tagging a third portion of the analysis data set, determining a recipient of the analysis data set, or requesting secondary authorization to transmit, access, and/or upload the analysis data set. In other features, the analysis data set does not include a name of the recipient.

In other features, the set of rules includes at least one of determining a quantity associated with the entry in the analysis data set, determining a recipient of the analysis data set, or determining a security level requirement with the analysis data set.

In other features, the learning data set and the analysis data set include at least one of text data, image data, audio data, metadata, video data, machine-readable data, or executable program data. In other features, the method includes preprocessing the analysis data set and the learning data set. Preprocessing the analysis data set and the learning data set includes at least one of performing hypertext markup language (HTML) extraction, performing optical character recognition, transcribing, translating, performing machine vision analysis, data extraction, chunking, or performing data escaping.

In other features, the method includes, in response to the determination that the second subset of elements is similar to the at least one related entry, submitting the first subset of elements, the second subset of elements, and the analysis data set to a machine learning model. In other features, the method includes, verifying, via the machine learning model, whether the first subset of elements corresponds to the entry.

In other features, the method includes determining a first score based on a frequency of the entry in the analysis data set. In other features, the method includes determining a second score based on a frequency of the entry in a second set of data. In other features, the method includes determining, based on the first score and the second score, a likelihood that the first subset of elements match the entry. In other features, the method includes determining whether the likelihood meets a threshold likelihood level and in response to determining that the likelihood does not meet the threshold likelihood level, determining that the first subset of elements do not correspond to the entry.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is an example knowledge graph.

FIG. 2 is a flowchart of an example method for generating a knowledge graph.

FIGS. 3A-3D are a flowchart of an example method for analyzing data for context and rule applicability.

FIG. 4 is a flowchart of an example method for determining whether to perform an automated action.

FIG. 5 is a flowchart of an example method for applying a data policy rule.

FIG. 6 is a block diagram of an example system environment for automatically determining data context and performing automated actions.

FIG. 7 is a block diagram of an example filtering engine for determining data context and performing automated actions.

In the drawings, reference numbers may be reused to identify similar and/or identical elements.

### DETAILED DESCRIPTION

### Introduction

The present disclosure describes systems and methods for automatically determining the context of data (such as a document, email, message, and/or digital file of any type) and, based on the data context and data policies that govern the data, performing various automated actions. In various embodiments, the automated actions are designed to prevent information leakage of confidential, private, inaccurate, or inappropriate data. For example, as the use of large language models (LLMs) increases, more and more LLM-generated content is created. However, the LLM-generated content may be based on private or inaccurate data. The present disclosure describes determining the context of data via entity linking. Based on a knowledge graph of known entities (and their relationships to each other), data context can be determined with a high likelihood of certainty and one or more remedial actions can be selected and performed.

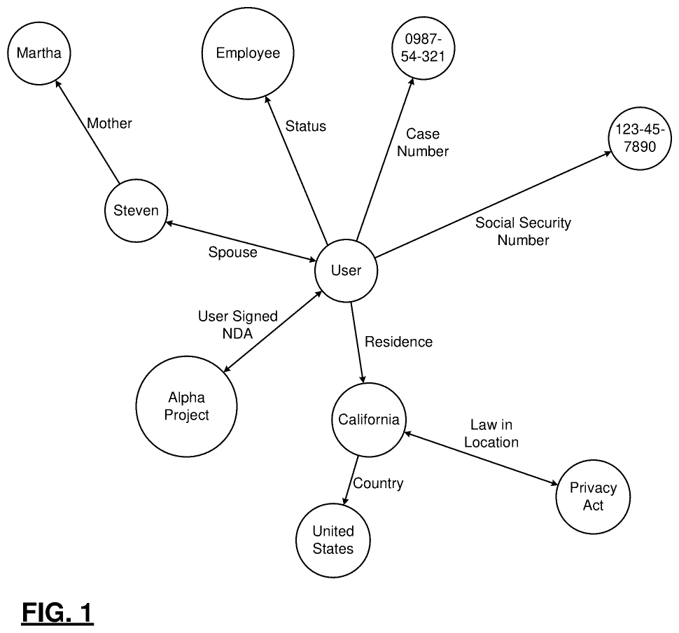

FIG. 1 is an example knowledge graph depicting various relationships of a user. A structure storing relationships of information provides an accurate record for determining data context. For the user shown in FIG. 1, an example communication (such as an email) may include several numbers and text passages. Using a variety of data extractors, a case number (such as “0987-54-321”) and data related to a top-secret project (“Alpha Project”) are identified. Using the knowledge graph of FIG. 1, it is determined that the user has signed a non-disclosure agreement (“NDA”) related to the top-secret project and is therefore authorized to receive the information in the email. As another example, an email with the user as a recipient includes ten social security numbers. Using the knowledge graph, one of the social security numbers is identified as belonging to the user; however, the other nine are not. Therefore, the email is blocked from being delivered due to the privacy violation.

In various embodiments, the content is analyzed without using the knowledge graph. For example, content such as email can be analyzed for inappropriate content (such as use of certain terms, phrases, or adult content) independent of the knowledge graph. As another example, content such as email can be analyzed to confirm that the content conforms with a regulation (such as insurance requirements or a human resources guideline). As an example, an email discussing insurance coverage of $5,000 in a region that requires $15,000 of coverage is flagged for additional review.

The present disclosure can be thought of in two phases: learning and analysis. Learning includes receiving a first data set to create the knowledge graph. Once the knowledge graph has been created, the analysis phase can be performed. Analysis includes comparing a second set of data (such as documents or emails) to the created knowledge graph. Once the data has been identified with a high (or a threshold) level of confidence, the data is analyzed to determine whether it is compliant with a data policy. The phases may overlap, and the learning phase may continue (for example, continuously or periodically) during the analysis phase.

### Learning (Creating the Knowledge Graph)

The first step for analyzing data is to create a knowledge graph. The knowledge graph can be created with any set of data. For example, the knowledge graph can be built with user data, project data, product data, etc. In various embodiments, the knowledge graph is built using data related to the type of data that will be monitored for context and compliance with a data policy. In various embodiments, the data used for the knowledge graph includes structured (such as SQL or database data), semi-structured data (such as JSON), or unstructured data. In various embodiments, the data used to build the knowledge graph is analyzed with various data extractors including modules and machine learning models to classify data, identify unique identifiers (such as unique numbers, titles, or headings), generate embeddings calculations, and generate terms and/or entities using natural language processing (NLP), named entity recognition (NER), regular expressions, LLMs, and other methods. In various embodiments, the various data extractors may produce redundant or overlapping terms and entities. In various embodiments, duplicate entities and/or terms are grouped with an overarching entity and the potentially duplicate entities/terms are maintained separately in case one or more of the entities/terms are not duplicates. For example, two potentially duplicate entities named “Steve” are not merged, but are assumed to be the same entity. In various embodiments, duplicate entries are removed and/or ranked to determine the most relevant entries.

In various embodiments, the knowledge graph is updated or created via a machine learning model. In various embodiments, the machine learning model is trained with user feedback. For example, after determining a match, a user may transmit positive or negative feedback regarding the match, which can be used as training for the machine learning model.

### Example Method for Creating and Updating a Knowledge Graph

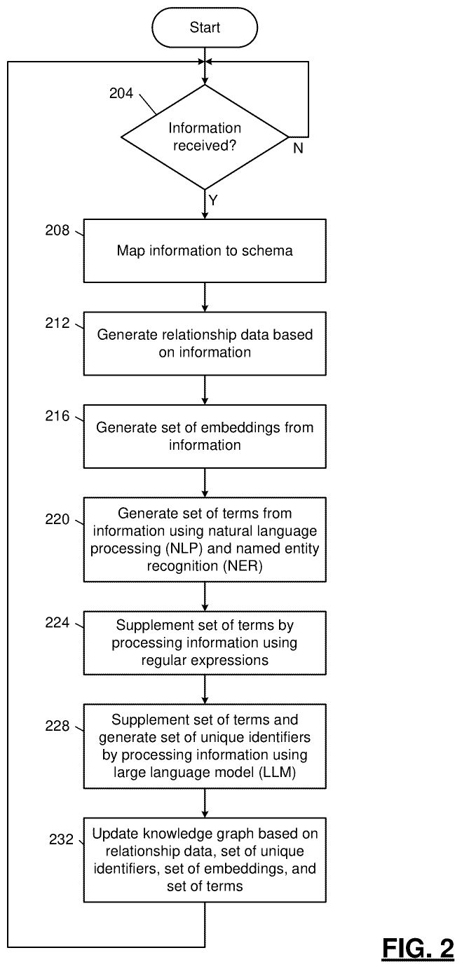

FIG. 2 is an example method for creating (and updating) a knowledge graph. In various embodiments, the steps described below are performed in different orders and/or performed in parallel. In various embodiments, the steps below are performed multiple times and/or iteratively. At 204, control determines whether a first data set (in other words, information used to create or update the knowledge graph) has been received. If the first data set has not been received, control remains at 204. If the first data set has been received, control transfers to 208. At 208, control maps the first data set to schema. In various embodiments, the schemas are generated from the first data set. In various embodiments, the schemas are user-defined. In various embodiments, the schemas are generated based on a source system of the first data set. In various embodiments, the schemas are generated via LLM. For example, the schemas are based on data labels or headings. At 212, control generates relationship data based on the first data set. For example, as seen in FIG. 1, generating relationship data includes determining that “User” and “Steven” have a spousal relationship and that the User has a residence relationship with California, USA.

At 216, control generates a set of embeddings based on the first data set. At 220, control generates terms using NLP and NER. At 224, control generates terms using regular expressions. For example, control identifies terms by identifying data that follows specific patterns such as dates, telephone numbers, social security numbers, etc. At 228, control generates terms and unique identifiers (such as names, social security numbers, employee number, plan number, etc.) using a large language model (LLM). For example, control may generate unique terms using an LLM by transmitting information and a prompt to the LLM to identify terms. In various embodiments, control uses the LLM to verify terms, identifiers, and relationships generated in previous steps of FIG. 2. At 232, control creates (or updates) the knowledge graph based on the relationship data, unique identifiers, embeddings, and terms.

### Data Analysis (Using the Knowledge Graph)

Once the knowledge graph has been generated, it can be used to determine the context of data. In various embodiments, the context of various types of data (such as emails, chat messages, audio and video files, documents, digital files, etc.) is determined. In various embodiments, data is analyzed prior to transmission. For example, an email (and its attachments) is analyzed before the email is sent; a chat message is reviewed after a user has selected a “send” icon, but before the message has been transmitted; or a file is analyzed before it is uploaded to a server. In various embodiments, the data analysis system runs continuously as a background task and is triggered when the transmission, access, and/or upload of data is attempted. In various embodiments, data analysis occurs periodically (for example, data is scanned every 5 minutes, 30 minutes, 1 hour, daily, etc.), independent of user action (such as transmission, access, or upload of data).

Once data (a second data set) has been received (in other words, once it has been determined that data should be analyzed), the second data set is preprocessed before substantive analysis is performed. In various embodiments, preprocessing includes chunking data, HTML extraction, data escaping, optical character recognition, machine vision analysis, translating, transcribing, etc.

After preprocessing the second set of data, the data is analyzed using data extractors to determine embeddings, terms, entities, classifiers, and/or data insights. In various embodiments, various metadata is also analyzed, such as senders, recipients, data size, message length, subject headings, etc. In various embodiments, the data extractors are the same extractors used to create the knowledge graph. In various embodiments, one or more LLMs are used to capture linguistic and semantic nuances. In various embodiments, NER techniques are applied to identify and classify entities in the data. Using a generative entity linking model, the extracted data terms are matched using the context of the data (for example, the semantic context of the data) to the knowledge graph entities'terms. In various embodiments, typographical errors, abbreviations, missing last names, etc. are removed and/or replaced with standardized terms.

Initial mappings are created between identified entities and knowledge graph nodes using a combination of direct term matching (such as using text similarity ranking algorithms and indirect matching using an embeddings vector search). In various embodiments, similarity is based on one or more matching substrings and/or a set of characters within a proximity threshold (such as a set of letters that appear in the same word but in a different order due to a spelling error). In various embodiments, similarity is based on embeddings. For example, data is converted into vector representations (embeddings) and the distance between the vectors is calculated using a similarity metric such as cosine similarity. Next a graph traversal algorithm is used to explore relationships and validate entity links based on the depth of connections and contextual relevance. For example, an analyzed email may discuss an entity named “Sean” which may have multiple possible matches in the knowledge graph. However, the email also contains an entity named “Sara.” The knowledge graph contains only one “Sean” with a relationship to an entity named “Sara.” Therefore, it is more likely that the knowledge graph entry with the Sean related to Sara is the Sean discussed in the email. In other words, the more links and context to an entry are found in the data, the higher confidence that the entities are a match.

Final entity links are confirmed through a scoring system that evaluates the strength of graph relationships and the contextual fit. In various embodiments, an LLM can also be used to verify the final entity mapping. For example, a prompt is transmitted to an LLM with the raw data (the second data set) and the candidate entity match that instructs the LLM to determine whether the raw data and the structured data are a match. Related entities are added from the knowledge graph to generate the final entity linking results.

As described in greater detail below, the final entity linking results are used to determine whether automated action(s) should be performed. In various embodiments, the determination of whether automated action(s) should be performed is based on insights (such as personal identifying information, disclaimers, toxicity, and other classifiers) from the data extractors. The determination of whether automated action(s) should be performed is based on the data policy rules. In various embodiments, determining whether automated actions should be performed is determined by an LLM based on agent tools, data policies, knowledge graph, and/or insights from the data extractors. In various embodiments, an LLM determines which action should be performed based on agent tools, data policies, knowledge graph, and/or insights from the data extractors. In various embodiments, the knowledge graph enhances results, produces an accurate confidence score for potential matches, and reduces false positives and false negatives.

### Example Method for Data Analysis Using a Knowledge Graph

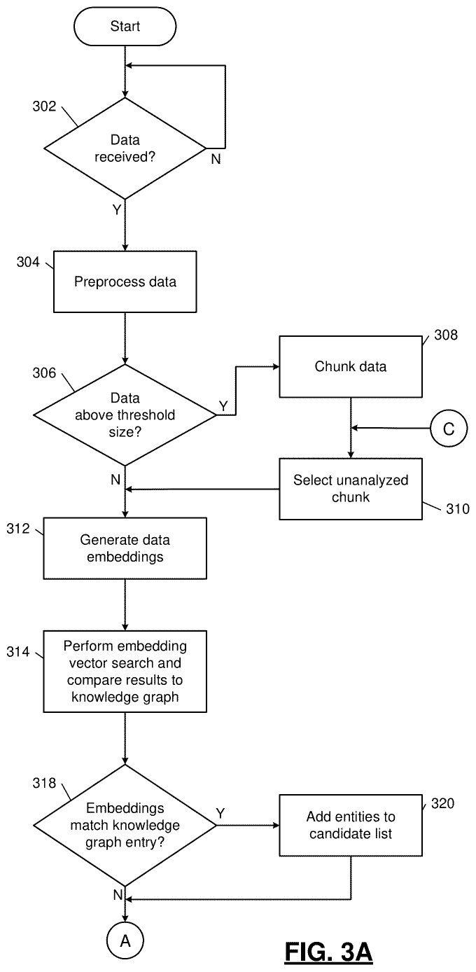

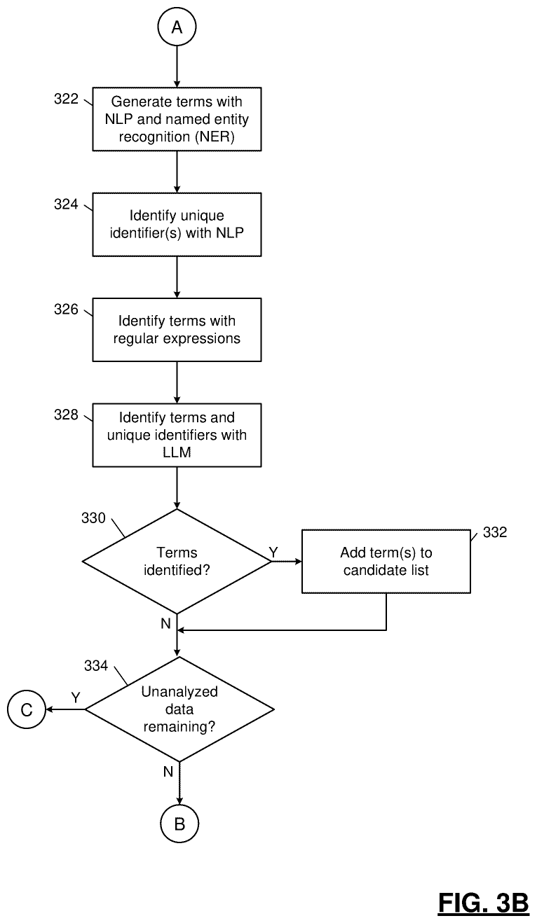

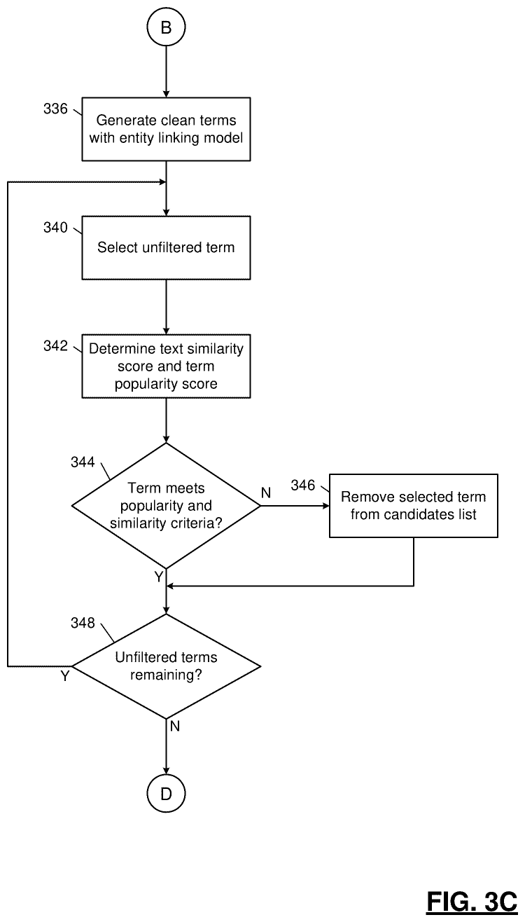

FIGS. 3A-3D are an example method for using a knowledge graph to analyze data. In various embodiments, the steps described by FIGS. 3A-3D are performed in parallel and/or in a different order than the order depicted in FIGS. 3A-3D. Control begins at 302 and determines whether data has been received. For example, received data includes an email that requires analysis. If no data has been received, control remains at 302. If data has been received, control continues to 304. At 304, control preprocesses the data. For example, preprocessing includes HTML extraction. After the data has been preprocessed, control continues to 306. At 306, control determines whether the data is above a threshold size (for example, a size larger than is capable of being analyzed by a machine learning model). If the data is above a threshold size, control transfers to 308 and chunks the data. If the data is not above a threshold size, control transfers to 312. In various embodiments, steps 306-310 are performed as a part of step 304. In various embodiments, step 306 is not performed and instead data chunking (as described by step 308) is always performed. After chunking the data, control continues to 310 and selects an unanalyzed data chunk.

After 310 control continues to 312 and generates embeddings for the data. At 314, control performs an embedding vector search of the knowledge graph and compares the embedding search results to the knowledge graph to determine if any of the knowledge graph entries are similar to the data. At 318, control determines whether any similar entries were found. In various embodiments, the similarity of the data and the knowledge graph entries is determined by mapping the received data to a first vector and a knowledge graph data entry to a second vector and determining the distance between the two vectors. If one or more embeddings match one or more knowledge graph entries, control transfers to 320 and the entries are added to the candidate entities list. Control then continues to 322. If no embeddings are potential matches to the knowledge graph, control continues to 322.

At 322, control generates terms using NLP and NER based on the data. At 324, control identifies unique identifiers from the data using NLP. At 326, control identifies terms with regular expressions. At 328, control identifies terms and unique identifiers using an LLM. In various embodiments, one or more terms are identified by multiple methods. For example, steps 322-328 each identify the term “Steven.” In various embodiments, the duplicate terms are merged into a single term. In various embodiments, the duplicate terms are kept separate to ensure that similar but distinct terms are not conflated.

At 330, control determines whether the previous steps identified any terms. If terms were identified, control transfers to 332 and adds the terms to the candidate list and continues to 334. If no terms were identified, control transfers to 334. At 334, control determines if there is unanalyzed data remaining (for example, additional data chunks). If there is unanalyzed data, control returns to 310. If all the data has been analyzed, control continues to 336.

At 336, control uses a generation entity linking model on the candidate terms to generate clean (for example, standardized and/or error-free) terms. At 340, control selects an unfiltered term. At 342, control determines the text similarity score (such as a score based on BM25, a score based on cosine similarity, a score based on constrained generation, and/or a score based on embeddings) and popularity score. In various embodiments, the popularity score is based on the occurrence rate (a frequency) of an entity in the data being analyzed when compared to the occurrence rate of the entity in a larger data set (such as a text sample of an encyclopedia). At 344 control determines whether the term meets the popularity score and similarity score thresholds. If the term does not meet the threshold, control transfers to 346 and the term is removed from the candidate terms. If the term meets the threshold, control continues to 348. At 348, control determines whether there are unfiltered terms remaining. If there are unfiltered terms remaining, control returns to 340. If there are no unfiltered terms remaining, control transfers to 350. In various embodiments, candidate terms are used to determine the entities. In various embodiments, the more terms that indicate the same entity, the higher confidence that the entity is associated with the terms/data.

At 350, control performs an additional candidate verification using an LLM. In various embodiments, the LLM is prompted to compare the raw data and the candidate entities to determine if they are a match. In various embodiments, candidates that are not verified by the LLM are removed from the candidate list. At 354, control performs graph-based disambiguation to further verify the candidate list. In various embodiments, invalid candidates are removed from the candidate list and/or the confidence score is lowered.

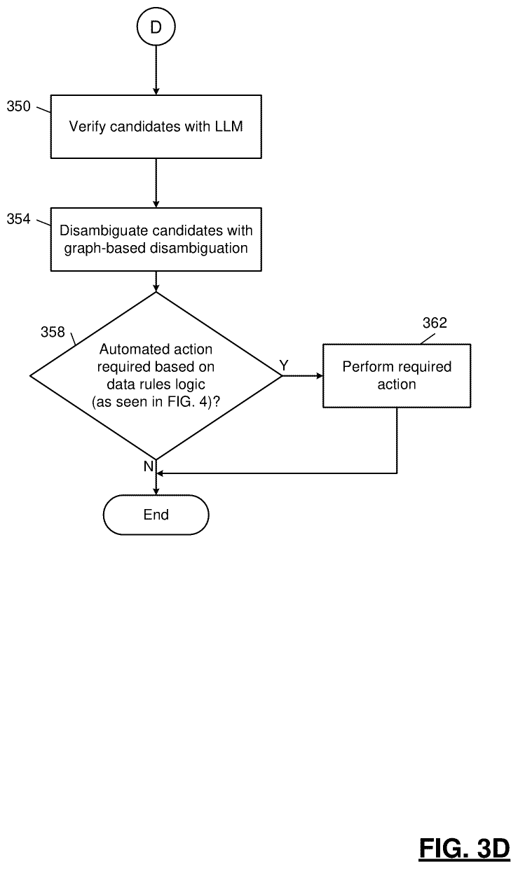

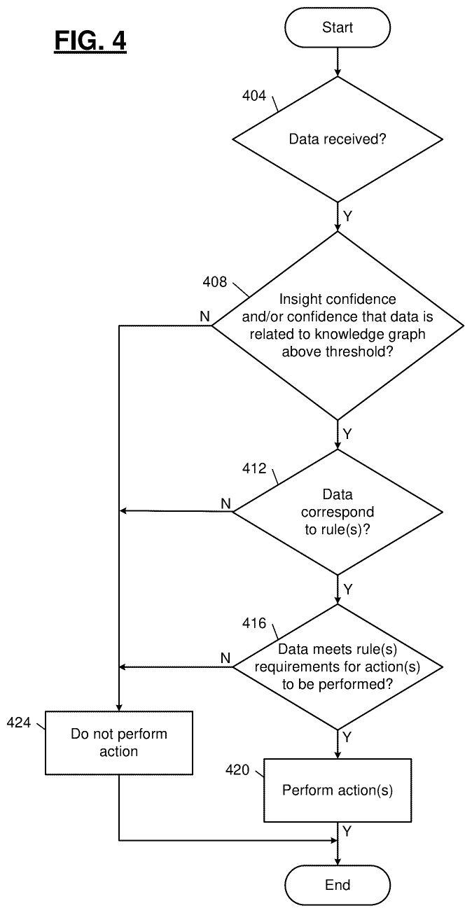

At 356, control determines whether automated action for the candidate entities is required. If automated action is required, control transfers to 362 and performs the action. If no action is required, control ends. In various embodiments, step 358 and step 362 are performed multiple times for each candidate entity. In various embodiments, step 358 and step 362 are replaced with the method described in FIG. 4

### Data Policy Rules

The data policy rules include logic for how data should be used. In various embodiments, the data rules logic is received from a third-party system. In various embodiments, the data rules logic is based on privacy requirements, accuracy requirements, legal requirements, ethics requirements, confidentiality requirements, etc. For example, the data rules may prohibit personal identifying information from being shared with unauthorized recipients; confidential information from being shared with recipients that have not signed an NDA; and/or prevent inappropriate language or images (such as toxic or pornographic communications) from being shared. In various embodiments, the data policy rules are expressed in natural language and/or logical expressions. In various embodiments, data policy rules are evaluated by a module that evaluates the logic expressions of the data policy rules. In various embodiments, the data policy rules are evaluated by an agentic AI utilizing an LLM, the knowledge graph, insights from the data extractors, and/or entity linking results to evaluate the content, assess the confidence level associated with the potential matches, and recommend actions.

In various embodiments, data rules logic describes rules based on the content of the data. In various embodiments, the data rules logic determines whether action should be taken based on a quantity level of a type of content in the data (for example, is the toxicity or informality of the data above a threshold level and/or of a type of data is above a threshold quantity). For example, PII may be allowable if the amount of PII is below a threshold quantity. In various embodiments, the data rules logic determines whether action should be taken based on a confidence level that the data rules logic applies to the data content. For example, blocking data upload occurs when a threshold confidence level that the data is prohibited is above a confidence threshold. In various embodiments, rules are based on the location of senders, recipients, and/or the subject of the data. For example, residents of California may be subject to additional data privacy laws.

In various embodiments, the automated actions include encrypting the data. In various embodiments, the automated actions include redirecting data from a first recipient to a second recipient. In various embodiments, the automated actions include masking a portion of the data (for example, redacting a portion of the data or making the data unreadable). In various embodiments, the automated actions include deleting a portion of the data. In various embodiments, the automated actions include generating a log based on the data. In various embodiments, the automated actions include tagging (or labeling) the data. In various embodiments, the automated actions include blocking transmission of the data and/or preventing upload of the data. In various embodiments, the automated actions include generating and displaying an alert or notification that data is in violation of one or more data policy rules. In various embodiments, the automated actions include generating one or more tasks. In various embodiments, the automated actions include quarantining some or all of the data. In various embodiments, the automated actions include preventing access to the data. In various embodiments, the automated actions include moving (or adding) the data to a secondary data storage location. In various embodiments, the automated actions include initiating an incident response process. In various embodiments, multiple automated actions are performed based on whether the data relates to multiple data policy rules and/or whether the data policy rule specifies that multiple actions should be taken. In various embodiments, the automated actions include requesting approval before data is transmitted, accessed, and/or uploaded. In various embodiments, approval is received via a user (for example, via authorized user interaction with an alert generated by the automated action). In various embodiments, approval is determined by an authorization module.

In various embodiments, the data rules logic is generated based on a set of data. In various embodiments, the data rules logic is refined over time based on user feedback. For example, when a rule is applied to a portion of the data, the user is presented with an option to indicate whether the match was correct (positive reinforcement) or incorrect (negative reinforcement).

### Example Methods for Data Compliance Analysis

FIG. 4 is a flowchart of an example method for determining whether to perform an automated action. Control begins at 404 and determines whether data has been received. For example, received data includes entities that have been found similar to entities in the knowledge graph. If no data has been received, control remains at 404. If data has been received, control transfers to 408.

At 408, control determines whether the received data (the entities) have been matched with entities from the knowledge graph with a threshold level of confidence and/or whether the confidence that the insights are accurate with a second threshold level of confidence. If the similarity confidence threshold and/or insights confidence threshold has not been met, then control transfers to 424 and no action is performed, after which control ends. In various embodiments, instead of transferring to 424, control continues to 412. For example, in various embodiments, a lack of matching entities may indicate that data is being sent to unknown (and/or unauthorized) senders and therefore action should be taken to prevent transmission. If the confidence threshold has been met, then control transfers to 412 and determines whether the data corresponds to one or more data policy rules. If the data does not correspond to one or more data policy rules, control transfers to 424. If the data corresponds to one or more data policy rules, control transfers to 416. At 416, control determines whether the data meets the criteria specified by the corresponding data policy rule for automated action(s) to be performed. If the criteria specified by the corresponding data policy rule have not been met, control transfers to 424 and no action is performed. If the criteria have been met, control transfers to 420 and performs the action(s) and control ends. In various embodiments, the method of FIG. 4 repeats multiple times for each rule that corresponds to an entity and/or for each action associated with a rule.

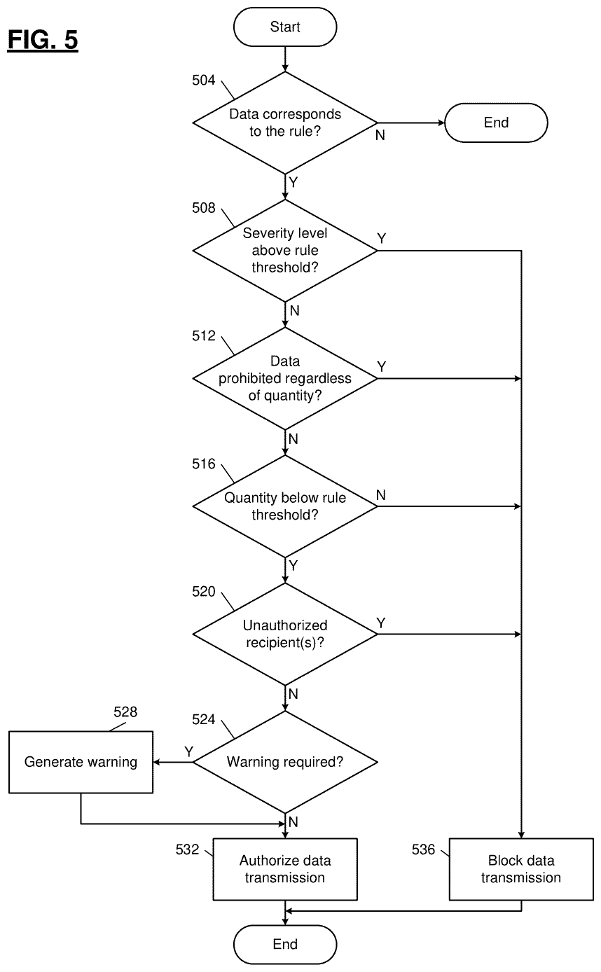

FIG. 5 is a flowchart of using example data rules logic to determine whether to perform an automated action. In various embodiments, data policy rules include different, fewer, or additional criteria. In various embodiments, data policy rules specify different, fewer, or additional actions. Control begins at 504 and determines whether the data corresponds to the data policy rule. If the data does not correspond to the data policy rule, control ends. In various embodiments, control determines whether the data corresponds to a different data policy rule. If the data corresponds to the data policy rule, control transfers to 508. At 508, control determines whether the severity level of the rule breach of the data is above a threshold dictated by the data policy rule. If the severity level has been exceeded, control transfers to 536 and the data transmission is blocked. If the severity level has not been exceeded, control transfers to 512. At 512, control determines whether the data is prohibited regardless of a quantity associated with the data. For example, whether a typographical error is allowable if the quantity is below a threshold. If the data is prohibited regardless of quantity, control transfers to 536. If the data is not prohibited regardless of quantity (in other words, the data is allowable if below a quantity threshold), control transfers to 516. At 516, control determines whether the data is below the rule threshold. If the data is not below the rule threshold, control transfers to 536. If the data is below the rule threshold, control transfers to 520.

At 520, control determines whether the data is associated with any unauthorized recipients. For example, the determination of whether the data is associated with an unauthorized recipient includes a determination of whether the recipient has signed an NDA, and/or whether the data is related to the recipient. If the data is associated with any unauthorized recipients, control transfers to 536. If the data is not associated with any unauthorized recipients, control transfers to 524. At 524, control determines whether the data requires a warning (such as an alert or notification) to be transmitted to a user. If a warning is required, control transfers to 528 and a warning is generated. Control then continues to 532. If a warning is not required, control transfers to 532 and the data is transmitted.

### Example System

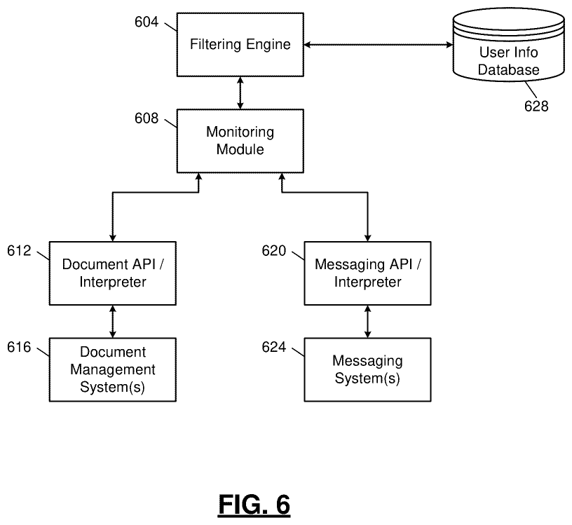

FIG. 6 is a block diagram of an example system environment for filtering engine 604. Filtering engine 604 generates the knowledge graph using information received from user info database 628 (also described as the first data set). In various embodiments, user info database 628 includes various types of data such as user data, project data, historical data, etc. In various embodiments, user info database 628 includes structured and/or unstructured data.

Filtering engine 604 also analyzes data received from monitoring module 608 to determine whether to perform automated action based on the content and context of the received data (which together are also described as the second data set). Monitoring module 608 monitors various communication and/or data transmission methods. For example, monitoring module 608 monitors data in document management system(s) 616 and messaging system(s) 624 via document API/interpreter 612 and messaging API/interpreter 620, respectively. In various embodiments, document management system(s) 616 and messaging system(s) 624 include various applications and programs such as chatbots, chat and/or messaging services, email services, cloud storage, document editors, etc.

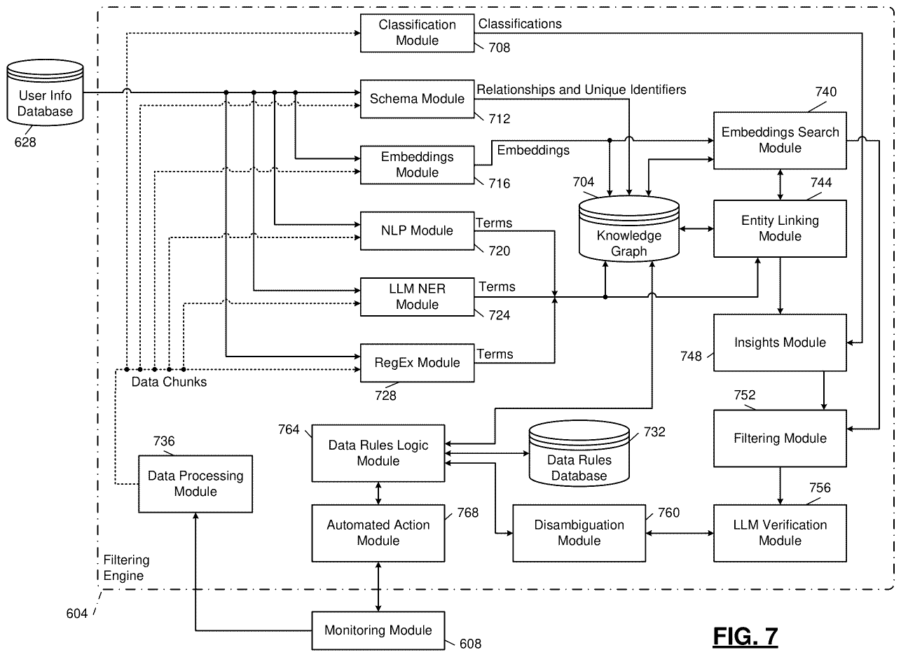

FIG. 7 is a block diagram of an example system of filtering engine 604. As described above, filtering engine 604 receives data (the first data set) from user info database 628 to generate knowledge graph 704 and data (the second data set) from monitoring module 608 to determine whether to take automated action related to the second data set.

Data received from user info database 628 (the first data set) is analyzed by several data extractors: schema module 712, embeddings module 716, NLP module 720, LLM NER module 724, and regex module 728. In various embodiments, additional data extractors are used to analyze the data from user info database 628. In various embodiments, additional or fewer data extractors are used to analyze data from the user info database 628. In various embodiments, the data extractors include an agent LLM module that analyzes data using LLMs, agent tools, and/or data policy rules. In various embodiments, the data extractors include one or more machine learning models. In various embodiments, the data extractors determine a confidence level associated with the insights produced by the data extractors. In various embodiments, the confidence level is used to determine whether automated actions should be performed.

Schema module 712 generates relationships and unique identifiers found in the first data set. For example, categories or data types. Embeddings module 716 calculates embeddings. NLP module 720 uses NLP and NER to determine entities and unique identifiers found in the first data set. LLM NER module 724 also uses NLP and NER to determine entities and unique identifiers found in the first data set.

Regex module 728 (also known as regular expression module 728) generates terms by determining whether a portion of the first data set (such as a string or substring) matches a particular data pattern. In various embodiments, data patterns might be based on patterns detected in the data (such as case numbers that have a specified format) or predefined patterns (such as social security numbers, addresses, telephone numbers, etc.).

The relationships, unique identifiers, embeddings, and terms determined by the data extractors are used to generate (and/or update) knowledge graph 704. Knowledge graph 704 is used by filtering engine 604 to analyze data received by monitoring module 608 (the second data set) to determine the context of the second data set and whether actions need to be executed based on data policy rules stored in data rules database 732. The second data set is preprocessed at data processing module 736 into chunks, which are then transmitted to the data extractors. The data extractors (schema module 712, embeddings module 716, NLP module 720, LLM NER module 724, and regex module 728) are used to determine relationships, unique identifiers, embeddings, and terms that are compared to knowledge graph 704. For example, regex module 728 first determines terms to add to knowledge graph 704 based on the first data set, and when filtering engine 604 performs analysis of the second data set, regex module 728 determines terms that will be analyzed for similarities to the terms of knowledge graph 704. As another example, schema module 712 determines the various data types of the first data set and later determines whether entities found in the second data can be grouped into the various data types.

In various embodiments, terms are extracted from data via various data extractors and are matched to terms extracted from entities during the learning process. Embeddings search module 740 performs an embeddings vector search of knowledge graph 704 to determine an initial group of candidate entities based on the embeddings determined by the data extractors. Entity linking module 744 determines the similarity of terms from the second data set to terms in knowledge graph 704. In various embodiments, entity linking module 744 standardizes terms used in the second set of data. For example, standardization includes removing typographical errors, replacing abbreviations with the full term, adding missing last names, etc.

In addition to the data extractors used to generate knowledge graph 704, classification module 708 generates classifications, labels, and/or tags for the second data set. For example, classification module 708 analyzes information via a machine learning module to determine whether data includes toxic, informal, or otherwise inappropriate language or content and labels the data as such. As another example, classification module 708 analyzes information to determine whether a message is an internal message (a message sent between members of an organization), external message (a message sent from a member of an organization to a non-member), formal or informal message, whether the message contains inappropriate or adult content, whether the message violates or discusses violating a third-party regulation (such as sending private information and/or discussing an insurance policy that does not meet minimum requirements), etc.

Classifications from classification module 708 are used by insights module 748. In various embodiments, the data extractors also generate insights that describe the context and metadata of the second data set. For example, if regex module 728 identifies a social security number, an insight is generated that the social security number is personal identifying information (PII) and needs to be transmitted with additional security measures. In various embodiments, the data policy rules of data rules database 732 include rules that are not related to content of the second data set, but instead are directed to the metadata of the content. For example, whether the data has been identified to be informal, inappropriate, or is otherwise highly sensitive. Insights module 748 transmits the candidate entities and the associated insights to filtering module 752. The insights are used by data rules logic module 764 to determine which data policy rules are applicable to the second data set. As another example, a PII extractor of classification module 708 analyzes data and finds PII in data which can be used in conjunction with the data rules policy to determine actions and in conjunction with entity linking module 744 to identify people associated with the PII.

Filtering module 752 performs a variety of filtering actions to narrow the number of candidate entities to a set of high-likelihood candidate entities, which increases the accuracy of matching the second set of data to the data context stored in knowledge graph 704. In various embodiments, filtering module 752 performs popularity filtering. In various embodiments, filtering module 752 performs unique identifiers filtering and, in various embodiments, performs filtering based on a text similarity score of the candidate entities. After filtering is performed, the high-likelihood candidate entities are transmitted to LLM verification module 756.

LLM verification module 756 performs a second layer of verification for the high-likelihood candidate entities. In various embodiments, the raw (unprocessed data including all additional context) second data set and the high-likelihood candidate entities (for example, in JSON form) are transmitted to an LLM. The LLM is then prompted to determine whether the raw second data set and the high-likelihood candidates are the same entities.

Disambiguation module 760 performs a final layer of verification for the high-likelihood candidate entities. In various embodiments, disambiguation module 760 compares the number of graph relationships of the high-likelihood candidate entities. For example, an analyzed email may discuss an entity named “Sean” which may have multiple possible matches in the knowledge graph. However, the email also contains an entity named “Sara.” The knowledge graph contains only one “Sean” with a relationship to an entity named “Sara.” Therefore, it is more likely that the knowledge graph entry with the Sean related to Sara is the Sean discussed in the email. In other words, the more links and context to an entry found in the data, the higher the confidence will be that there is a match.

Data rules logic module 764 determines whether the related entities from disambiguation module 760 meet the criteria for automated action to be performed based on the data policy rules stored in data rules database 732. In various embodiments, data rules logic module 764 determines whether the confidence that the entities found in the second data set are a match for the related entities of knowledge graph 704. In various embodiments, data rules logic performs actions when the confidence has met a confidence threshold. In various embodiments, the confidence threshold is dependent on the rule associated with the related entity. Data rules logic module 764 determines whether there are one or more rules stored in data rules database 732 that are associated with the related entities transmitted by disambiguation module 760. If there are one or more rules associated with the related entities, data rules logic module 764 determines whether the related entities have met the criteria for performing automated actions as described by the associated rules.

In various embodiments, the data policy rules of data rules database 732 are stored as a set of logical functions (such as if-then statements written in a programming language). In various embodiments, the data policy rules are stored as plain text that is interpreted by a machine learning model included or used by data rules logic module 764. In various embodiments, the data policy rules are stored as structured data (such as JSON data) with various terms, actions, and conditions.

Based on whether the criteria for action as described by data rules database 732 have been met, data rules logic module 764 instructs automated action module 768 to perform the automated action. In various embodiments, automated action module 768 interacts with monitoring module 608 to interact with the various document and/or messaging services. In various embodiments, automated action module 768 executes one or more predefined scripts. In various embodiments, automated action module 768 interacts with one or more application APIs to execute the automated action. In various embodiments, automated action module 768 generates one or more scripts using a machine learning model.

### Conclusion

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

As noted below, the term “set” generally means a grouping of one or more elements. However, in various implementations a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” can be replaced with the term “controller” or the term “circuit.” In this application, the term “controller” can be replaced with the term “module.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); processor hardware (shared, dedicated, or group) that executes code; memory hardware (shared, dedicated, or group) that is coupled with the processor hardware and stores code executed by the processor hardware; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2020 (also known as the WIFI wireless networking standard) and IEEE Standard 802.3-2018 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term memory hardware is a subset of the term computer-readable medium.

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The term “set” generally means a grouping of one or more elements. The elements of a set do not necessarily need to have any characteristics in common or otherwise belong together. The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR.

1. A system comprising:
memory hardware configured to store instructions; and
processing hardware configured to execute the instructions stored by the memory hardware, wherein the instructions include:
receiving an analysis data set,
generating a set of elements associated with the analysis data set,
determining whether a first subset of elements of the set of elements is similar to an entry of a knowledge graph, and
in response to a determination that the first subset of elements is similar to the entry of the knowledge graph:
traversing the knowledge graph to determine a set of related entries based on the entry,
determining whether a second subset of elements of the set of elements is similar to at least one related entry of the set of related entries,
in response to a determination that the second subset of elements is similar to the at least one related entry, determining whether the entry or the at least one related entry is associated with a set of rules, and
in response to a determination that the entry or the at least one related entry is associated with the set of rules, determining whether to perform a set of actions.

2. The system of claim 1, wherein the set of elements includes at least one of:
a first set of terms,
a first set of entities,
a first set of embeddings, or
a first set of unique identifiers.

3. The system of claim 2, wherein generating the set of elements includes at least one of:
using regular expressions to determine at least one data type associated with the analysis data set,
identifying, using natural language processing (NLP), a first entity of the first set of entities,
identifying, using NLP, the first set of unique identifiers based on the analysis data set,
determining the first set of embeddings,
identifying, using a large language model (LLM), a second entity of the first set of entities, or
identifying, using the LLM, a second unique identifier of the first set of unique identifiers.

4. The system of claim 1, wherein determining whether the first subset of elements is similar to the entry includes:
determining a confidence level that the first subset of elements is similar to the entry,
determining whether the confidence level meets a confidence threshold, and
in response to a determination that the confidence level meets the confidence threshold, determining that the first subset of elements is at least a partial match of the entry.

5. The system of claim 4, wherein determining the confidence level is based on at least one of:
whether the first subset of elements and the entry include a data pattern, or
whether a substring of the first subset of elements matches a substring of the entry.

6. The system of claim 5, wherein the data pattern is defined by one or more predefined regular expressions.

7. The system of claim 5, wherein:
determining the confidence level is based on whether the substring of the first subset of elements matches the substring of the entry, and
one or more matching substrings include at least one of:
one or more same characters in a same order, or
one or more same characters within a proximity threshold.

8. The system of claim 4, wherein:
determining whether the first subset of elements is similar to the entry is performed by a first machine learning model,
the confidence level is determined by the first machine learning model, and
the instructions include:
receiving user input related to the determination that the first subset of elements is similar to the entry, and
training the first machine learning model with the user input.

9. The system of claim 4, wherein determining whether to perform the set of actions includes:
in response to a determination that the confidence level meets the confidence threshold, determining, based on the first subset of elements and the second subset of elements, whether a set of rules criteria associated with the set of rules has been met, and
in response to a determination that the set of rules criteria has been met:
determining the set of actions, wherein the set of actions is based on the set of rules, and
performing the set of actions.

10. The system of claim 9, wherein the set of actions includes at least one of:
masking a first portion of the analysis data set,
modifying a second portion of the analysis data set,
tagging a third portion of the analysis data set,
determining a recipient of the analysis data set, wherein the analysis data set does not include a name of the recipient, or
requesting secondary authorization to transmit, access, and/or upload the analysis data set.

11. The system of claim 1, wherein the instructions include:
receiving an additional set of data, and
merging, via a second machine learning model, the knowledge graph with the additional set of data.

12. The system of claim 1, wherein the instructions include:
receiving the set of rules;
receiving a set of user input related to a respective rule of the set of rules; and
in response to receiving the set of user input, updating the respective rule, including at least one of:
modifying a set of application criteria of the respective rule, or
modifying a set of actions associated with the respective rule.

13. The system of claim 1, wherein the instructions include:
receiving a set of data management restrictions, and
generating, via a machine learning model, a second set of rules based on the set of data management restrictions.

14. The system of claim 1, wherein the set of rules includes at least one of:
determining a quantity associated with the entry in the analysis data set,
determining a recipient of the analysis data set, or
determining a security level requirement with the analysis data set.

15. The system of claim 1, wherein the instructions include updating the knowledge graph by:
receiving a learning data set,
determining a set of schemas based on the learning data set,
determining, via embedding calculations, a second set of embeddings,
determining a set of terms by:
determining, via natural language processing (NLP), a second set of named entities,
determining, via NLP, a second set of unique identifiers,
determining, using regular expressions, a set of data types associated with a portion of the learning data set, and
determining, via an LLM, a third set of unique identifiers and a third set of named entities, and
adding the set of schemas, the second set of embeddings, and the set of terms to the knowledge graph.

16. The system of claim 15, wherein:
the learning data set and the analysis data set include at least one of:
text data,
image data,
audio data,
metadata,
video data,
machine-readable data, or
executable program data;
the instructions include preprocessing the analysis data set and the learning data set; and
preprocessing the analysis data set and the learning data set includes at least one of:
performing hypertext markup language (HTML) extraction,
performing optical character recognition,
transcribing,
translating,
performing machine vision analysis,
data extraction,
chunking, or
performing data escaping.

17. The system of claim 1, wherein the instructions include:
in response to the determination that the second subset of elements is similar to the at least one related entry, submitting the first subset of elements, the second subset of elements, and the analysis data set to a machine learning model, and
verifying, via the machine learning model, whether the first subset of elements corresponds to the entry.

18. The system of claim 1, wherein the instructions include:
determining a first score based on a frequency of the entry in the analysis data set,
determining a second score based on a frequency of the entry in a second set of data,
determining, based on the first score and the second score, a likelihood that the first subset of elements match the entry,
determining whether the likelihood meets a threshold likelihood level, and
in response to determining that the likelihood does not meet the threshold likelihood level, determining that the first subset of elements do not correspond to the entry.

19. A non-transitory computer-readable medium comprising processor-executable instructions, the instructions including:
receiving an analysis data set,
generating a set of elements associated with the analysis data set,
determining whether a first subset of elements of the set of elements is similar to an entry of a knowledge graph, and
in response to a determination that the first subset of elements is similar to the entry of the knowledge graph:
traversing the knowledge graph to determine a set of related entries based on the entry,
determining whether a second subset of elements of the set of elements is similar to at least one related entry of the set of related entries,
in response to a determination that the second subset of elements is similar to the at least one related entry, determining whether the entry or the at least one related entry is associated with a set of rules, and
in response to a determination that the entry or the at least one related entry is associated with the set of rules, determining whether to perform a set of actions.

20. A method comprising:
receiving an analysis data set,
generating a set of elements associated with the analysis data set,
determining whether a first subset of elements of the set of elements is similar to an entry of a knowledge graph, and
in response to a determination that the first subset of elements is similar to the entry of the knowledge graph:
traversing the knowledge graph to determine a set of related entries based on the entry,
determining whether a second subset of elements of the set of elements is similar to at least one related entry of the set of related entries,
in response to a determination that the second subset of elements is similar to the at least one related entry, determining whether the entry or the at least one related entry is associated with a set of rules, and
in response to a determination that the entry or the at least one related entry is associated with the set of rules, determining whether to perform a set of actions.
